(19) United States
(12) Patent Application Publication
(10) Pub. No.: US 2007/0251653 A1
(43) Pub. Date: Nov. 1, 2007

(54) Cord-controlling device for a window blind

(76) Inventor: Tai-Ping Liu, Taichung Hsien (TW)

Correspondence Address: Thomas E. Sisson;Jackson Walker, LLP, Suite 2100, 112 E. Pecan, San Antonio, TX, 78205, US

(21) Appl. No.: 11/415,134

(22) Filed: May 1, 2006

(51) Int. Cl. E06B 9/307

(52) U.S. Cl. 160/177 R

(57) ABSTRACT

A cord-controlling device for a window blind has a case, a cap, a gear, a spindle, a roller, a base and a lid. The cap is mounted on the case and a cavity formed between the case and the cap. The gear is received between the cavity formed between the case and the cap. The spindle engages with the gear and extends out the case and cap. The roller is mounted on the front end of the spindle for a cord rolling around. The base is pivotally mounted on the bottom edge of the case and the cap for holding the roller. The lid is pivotally mounted on the top edge of the case and the cap. The cord-controlling device for a window blind prevents the cord from escaping from the roller by the cap, therefore, the cord may move smoothly around the roller.

### BACKGROUND OF THE INVENTION

1. Field of the Invention

The present invention relates to a cord-controlling device, and more particularly to a cord-controlling device for a window blind.

2. Description of Related Art

A conventional blind has multiple slats that can be adjusted at angle with a cord-controlling device mounted on the blind. With reference to FIG. 5, a conventional cord-controlling device has a case (90), a worm shaft, a gear (91), a spindle (92), a roller (93) and a cord (50). The worm shaft, the gear (91) and the spindle (92) are mounted inside the case (90). The roller (93) is mounted on the case (90). The spindle (92) has two ends, and one end is connected to the roller (93) and the other end is connected to the warm shaft that engages with the gear (91). The cord (50) is rolled around the roller (93), such that the roller (93) rotates the spindle (92) when the cord (50) is pulled. Consequently, the gear (91) is driven to rotate with the transmission of the warm shaft, and a transmission rod engaged with the gear (91) is driven to rotate for changing angles of the slats.

The conventional cord-controlling device provides the function of adjusting the blind simply by pulling the cord (50). However, the conventional cord-controlling device is mounted inside a rail of the blind and the cord (50) is simply mounted around the roller (93), the cord (50) may become loosened from the roller (93) when the cord (50) is pulled. Thus, the cord (50) is easily escaped from the roller (93).

To overcome the shortcomings, the present invention tends to provide a cord-controlling device to mitigate the aforementioned problems.

### SUMMARY OF THE INVENTION

The primary objective of the present invention is to provide a cord-controlling device for window blind that is convenient for use.

A cord-controlling device for a window blind has a case, a cap, a gear, a spindle, a roller, a base and a lid. The cap is mounted on the case and a cavity formed between the case and the cap. The gear is received between the cavity formed between the case and the cap. The spindle engages with the gear and extends out the case and cap. The roller is mounted on the front end of the spindle for a cord rolling around. The base is pivotally mounted on the bottom edge of the case and the cap for holding the roller. The lid is pivotally mounted on the top edge of the case and the cap.

The cord-controlling device for a window blind prevents the cord from escaping from the roller by the cap, therefore, the cord may move smoothly around the roller.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a cord-controlling device in accordance with the present invention;

FIG. 2 is an exploded perspective view of the cord-controlling device in FIG. 1;

FIG. 3 is a perspective view of a cord-controlling device in FIG. 1 with a cord mounted on the cord-controlling device;

FIG. 4 is a side view of the cord-controlling device in FIG. 1 with a cord mounted on the cord-controlling device; and

FIG. 5 is a perspective view of a conventional cord-controlling device in accordance with the prior art.

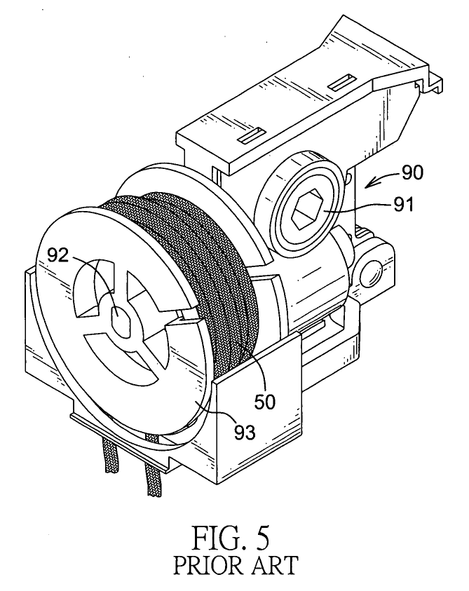

### DETAILED DESCRIPTION OF THE PREFERRED EMBODIMENT

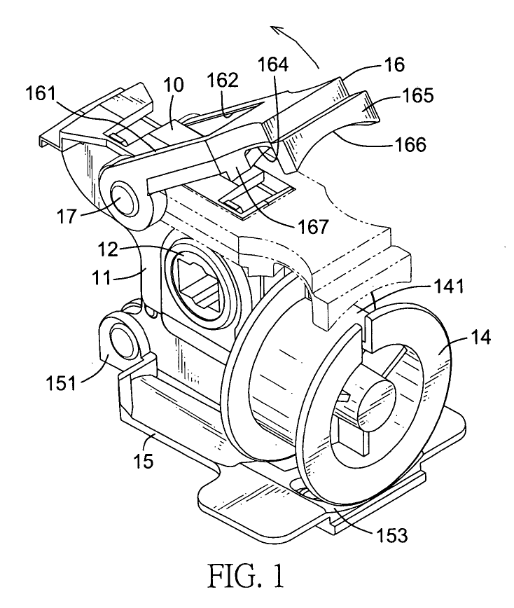

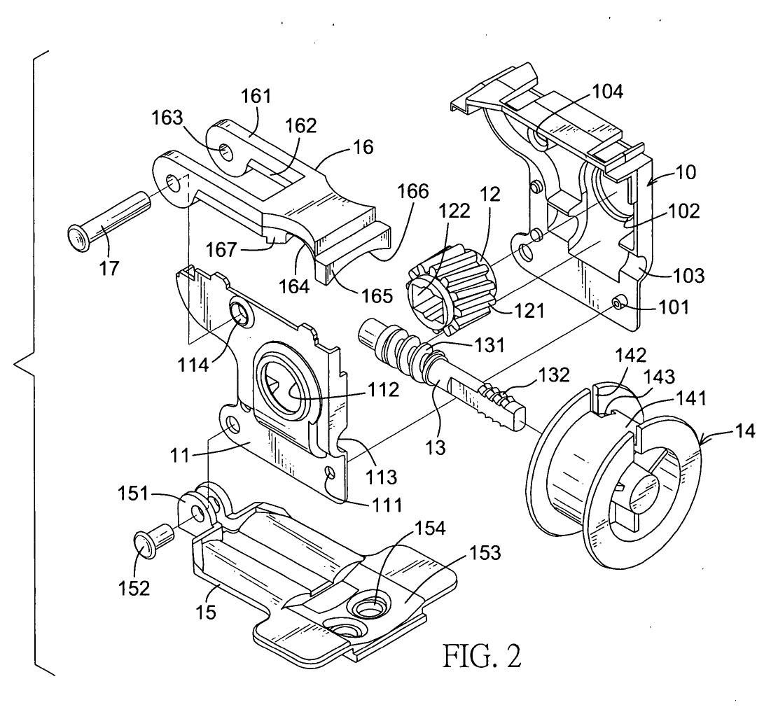

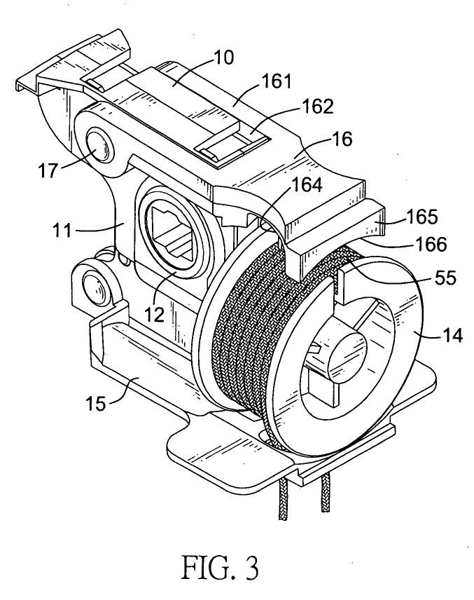

4 With reference to FIGS. 1 to 3, a cord-controlling device in accordance with the present invention has a case (10), a cap (11), a gear (12), a spindle (13), a roller (14), a base (15) and a lid (16).

The case (10) has an inner sidewall, a front side edge, a rear side edge, a top edge, a bottom edge, a post (101), a first mounting hole (102), a first recess (103) and a first pivot hole (104). The post (101) is formed on the inner sidewall near the front side edge and the bottom edge. The first mounting hole (102) is defined through the case (10) near the front side edge. The first recess (103) is defined in the inner sidewall above the post (101). The first pivot hole (104) is defined in the inner sidewall near the top edge and the rear side edge.

The cap (11) is mounted on the case (10) to form a cavity between the case (10) and the cap (11). The cap (11) has an inner sidewall, a front side edge, a rear side edge, a top edge, a bottom edge, a through hole (111), a second mounting hole (112), a second recess (113) and a second pivot hole (114). The through hole (111) is defined through the inner sidewall for the post (101) mounting through. The second mounting hole (112) is defined through the cap (11) and corresponds to the first mounting hole (102). The second recess (113) is defined in the inner sidewall and corresponds to the first recess (103). The second pivot hole (114) is defined in the inner sidewall and corresponds to the first pivot hole (104).

The gear (12) is mounted between the first mounting hole (102) and the second mounting hole (112) and received in the cavity formed between the case (10) and the cap (11). The gear (12) has an outer surface, a center, multiple inclined teeth (121) and a non-circular hole (122). The multiple inclined teeth (121) are formed around the outer surface of the gear (12). The non-circular hole (122) is defined through the center of the gear (12) for a non-circular transmission rod mounting through the non-circular hole (122).

The spindle (13) is mounted in the cavity formed between the case (10) and the cap (11) and extends out the case (10) and the cap (11). The spindle (13) engages with the gear (12) and has a front end, a rear end, a spiral tooth (131) and multiple teeth (132). The front end of the spindle (13) has two flat sidewalls and two cambered surfaces, and flat sidewalls and the cambered surfaces are both opposite to each other. The front end of the spindle (13) extends outside the case (10) and the cap (11). The spiral tooth (131) is formed on the outer surface of the rear end of the spindle (13) and engages with the inclined teeth (121) on the gear (12). The multiple teeth (132) are formed on the cambered surfaces on the front end.

The roller (14) is mounted on the front end of the spindle (13) for the cord (50) being rolled around. The roller (14) has a front edge, a rear edge, two lips, an outer surface (141), a slot (142) and a locking recess (143). The lips are respectively formed on the edges of the roller (14), and the outer surface (141) locates between the two lips. The slot (142) is defined in the lip at the rear edge. The locking recess (143) is defined in the outer surface (141) and communicates to the slot (142). The slot (142) and the locking recess (143) are used for holding the cord (50) well and prevent the cord (50) form loosing away.

The base (15) is pivotally mounted on the bottom edges of the case (10) and the cap (11) for holding the roller (14), so the base (15) can be pressed down to leave away from the roller (14). The base (15) has a top surface, a rear end, a front end, two ears (151), a rivet (152), a roller seat (153) and two cord holes (154). The two ears (151) are respectively formed at the rear end. The rivet (152) is mounted through the two ears (152), the case (10) and the cap (11) to pivotally connect the base (15) to the case (10) and the cap (11). The roller seat (153) is formed on the top surface for holding the roller (14). The two cord holes (154) are respectively defined through the roller seat (153) for the cord (50) passing through.

The lid (16) is pivotally mounted on the top edge of the case (10) and the cap (11). The lid (16) has a rear end, a front end, an inner surface, two arms (161), a recess (164), a stopper (165), an engaged tooth (167) and a pivot (17). The arms (161) are formed on the rear end of the lid (16). Each arm (161) has a rear end, an inner sidewall (162) and a pivoted hole (163). The pivoted hole (163) is defined in the arm (161) at the rear end for pivotally attaching the lid (16) onto the case (10) and the cap (11). The two inner sidewalls (162) are formed respectively on the arms (161) and selectively abut with the top edge of the case (10). The recess (164) is defined in the inner surface of the lid (16). The stopper (165) is formed on the front end of the lid (16) above the roller (14) and has a front end and a camber edge (166). The camber edge (166) is defined in the front end of the stopper (165). The stopper (165) is used for preventing the cord (50) form escaping from the roller (14). The engaged tooth (167) is formed on the inner surface of the lid (16) near the arms (161). The pivot (17) is mounted through the pivoted holes (163) defined in the arms (161), the cap (11) and the case (10) to pivotally attach the lid (16) to the cap (11) and the case (10).

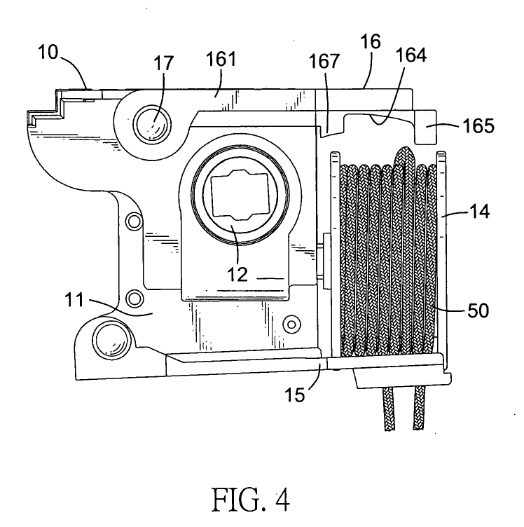

With reference to FIG. 4, when the cord (50) is mounted around the roller (14), the cord (50) are extended respectively through the cord holes (154) in the base (15) and held between the base (15) and the lid (16). Therefore, the cord (50) will not loosen from the roller (14) and prevent the cord (50) from entwining around the roller (14).

The advantages of the cord-controlling device for window blind of the present invention describe as follows.

The cord (50) is held in the cord holes (154) in the base (15) and mounted between the base (15) and the lid (16), therefore, the cord (50) will not escape easily from the roller (14). In addition, the cord (50) will move smoothly when the cord (50) is pulled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cord-controlling device for a window blind comprising:
a case having
a top edge, and
a bottom edge,
a cap mounted on the case to form a cavity between the case and the cap, and having
a top edge, and
a bottom edge,
a gear mounted between the case and the cap and receiving inside the cavity,
a spindle engaged with the gear in the cavity, extending out the case and the cap and having a front end,
a roller mounted on the front end of the spindle for a cord rolling around,
a base pivotally mounted on the bottom edge of the case and the cap for holding the roller, and
a lid pivotally mounted on the top edge of the case and the cap and having
a front end,
a rear end,
an inner surface,
a stopper formed on the front end of the lid above the roller for preventing the cord from escaping from the roller.

2. The cord-controlling device for window blind as claimed in claim 1, wherein the lid further comprises
two arms formed on the rear end of the lid, each arm having
a rear end,
an inner sidewall abutting with the top edge of the case, and
a pivot hole defined in the arm at the rear end for pivotally attaching the lid onto the case and the cap, and
a pivot mounted through the pivoted hole defined in the arm, the cap and the case.

3. The cord-controlling device for window blind as claimed in claim 2, wherein the lid further comprises
an engaged tooth formed on the inner surface of the lid near the arms.

4. The cord-controlling device for window blind as claimed in claim 3, wherein the stopper of the lid further comprises
a front end, and
a camber edge defined in the front end of the stopper.

5. The cord-controlling device for window blind as claimed in claim 4, wherein the lid further comprises a recess defined in the inner surface of the lid.

6. The cord-controlling device for window blind as claimed in claim 4, wherein the case comprises
an inner sidewall,
a front side edge,
a rear side edge,
a top edge,
a bottom edge,
a post formed on the inner sidewall near the front side edge and the bottom edge,
a first mounting hole defined through the case near the front side edge,
a first recess defined in the inner sidewall above the post, and
a first pivot hole defined in the inner sidewall near the top edge and the rear side edge, and
the cap further comprises
an inner sidewall,
a front side edge,
a rear side edge,
a top edge,
a bottom edge,
a through hole defined through the inner sidewall for the post of the case mounting through,
a second mounting hole defined through the cap and corresponding to the first mounting hole,
a second recess defined in the inner sidewall and corresponding to the first recess, and
a second pivot hole defined in the inner sidewall and corresponding to the first pivot hole.

7. The cord-controlling device for window blind as claimed in claim 6, wherein the gear has
an outer surface,
a center,
multiple inclined teeth formed around the outer surface of the gear, and
a non-circular hole defined through the center of the gear for a non-circular transmission rod mounting through the non-circular hole, and
the spindle has
a front end extending outside the case and the cap and having
two flat sidewalls and two cambered surfaces, both surfaces being opposite to each other,
a rear end,
a spiral tooth formed on the outer surface of the spindle and engaging with the inclined teeth on the gear, and
multiple teeth formed on the cambered surfaces.
